(19) United States
(12) Patent Application Publication
(10) Pub. No.: US 2025/0330814 A1
(43) Pub. Date: Oct. 23, 2025

(54) NETWORK WITH HIGH PRIORITY ENHANCED DISTRIBUTED CHANNEL ACCESS

(71) Applicant: Cisco Technology, Inc., San Jose, CA (US)

(72) Inventors: Brian D. HART, Sunnyvale, CA (US); Binita GUPTA, San Diego, CA (US)

(21) Appl. No.: 19/186,306

(22) Filed: Apr. 22, 2025

Related U.S. Application Data
(60) Provisional application No. 63/637,270, filed on Apr. 22, 2024.

(51) Int. Cl. H04W 12/082

(52) U.S. Cl. CPC H04W 12/082

(57) ABSTRACT

Described herein is a network that uses a high priority enhanced distributed channel access (HiP EDCA) policy. A wireless access point includes one or more memories and one or more processors communicatively coupled to the one or more memories. The one or more processors, individually or collectively, perform an operation that includes broadcasting a message comprising a portion of a HiP EDCA policy of the wireless access point and providing a user device access to a transmission medium using HiP EDCA according to the HiP EDCA policy.

### CROSS-REFERENCE TO RELATED APPLICATIONS

This application claims benefit of co-pending U.S. provisional patent application Ser. No. 63/637,270 filed Apr. 22, 2024. The aforementioned related patent application is herein incorporated by reference in its entirety.

### TECHNICAL FIELD

Embodiments presented in this disclosure generally relate to Wi-Fi networks. More specifically, embodiments disclosed herein relate to a network that uses a policy for high priority enhanced distributed channel access (HiP EDCA), which may also be referred to as Priority-EDCA (P-EDCA).

### BACKGROUND

Access points in Wi-Fi networks may manage, and under some circumstances, control access to a wireless transmission medium. User devices and the access points may take turns accessing the transmission medium to transmit and receive messages to and from each other. HiP EDCA allows certain user devices to receive higher priority to access the transmission medium (e.g., for certain flows or frames).

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates an example access point or device in the system of FIG. 1A.

FIG. 2A illustrates an example operation performed by the system of FIG. 1A.

FIG. 2B illustrates an example operation performed by the system of FIG. 1A.

FIG. 3 illustrates an example HiP EDCA request in the system of FIG. 1A.

FIG. 4 illustrates an example HiP EDCA policy in the system of FIG. 1A.

FIG. 5 illustrates an example HiP EDCA response in the system of FIG. 1A.

FIG. 6 illustrates an example operation performed by the system of FIG. 1A.

FIG. 7 is a flowchart of an example method performed by an access point in the system of FIG. 1A.

FIG. 8 is a flowchart of an example method performed by a device in the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a network that uses a HiP EDCA policy. According to an embodiment, a wireless access point includes one or more memories and one or more processors communicatively coupled to the one or more memories. The one or more processors, individually or collectively, perform an operation that includes broadcasting a message comprising a portion of a HiP EDCA policy of the wireless access point and providing a user device access to a transmission medium using HiP EDCA according to the HiP EDCA policy.

According to another embodiment, a method includes broadcasting a message comprising a portion of a HiP EDCA policy of a wireless access point and providing a user device access to a transmission medium using HiP EDCA according to the HiP EDCA policy.

According to another embodiment, a wireless access point includes one or more memories and one or more processors communicatively coupled to the one or more memories. The one or more processors, individually or collectively, perform an operation that includes receiving, from a user device, a request to access a transmission medium using HiP EDCA, determining that the request complies with a HiP EDCA policy of the wireless access point, and in response to determining that the request complies with the HiP EDCA policy, transmitting a response to the user device granting permission to access the transmission medium using HiP EDCA.

### Example Embodiments

Some access points and user devices in wireless networks implement high priority enhanced distributed channel access (HiP EDCA), which may be used to provide some of the user devices higher priority to access the wireless transmission medium (e.g., for certain flows or frames). Without proper management, some devices may use HiP EDCA too much or unfairly, which leads to congestion, unfairness, and/or failure to meet the network's goal(s).

The present disclosure describes a network in which the access points manage access to and use of HiP EDCA according to a HiP EDCA policy. Generally, an access point may advertise (e.g., via broadcast of unicast frames) a generic (e.g., device-independent) HiP EDCA policy (e.g. in Beacons, in Probe/Association/Reassociation Response). A user device may negotiate with the access point for permission to use HiP EDCA for the user device's specific circumstances. The user device's request may be sent in a (Re)Association Request, and the access point may communicate a tailored response—in place of the generic response—in a (Re)Association Response. Other frames (e.g., management frames) may be used to negotiate HiP EDCA usage after association. During the generic advertisement and/or negotiation, the access point may indicate to the device the parameters and/or limitations of using HiP EDCA according to a HiP EDCA policy of the access point. The access point may communicate a streamlined response that includes a reason code (e.g., indicating rejected, accepted, denied, etc. and extra details). If the device agrees to the policies, parameters, and/or limitations, however expressed, the device may determine that the access point has granted the device access to use HiP EDCA. The access point may then monitor the device's use of HiP EDCA and take remedial action if the device violates the HiP EDCA policy.

In certain embodiments, the network provides several technical advantages. For example, the network may control and manage access to and use of HiP EDCA, which may reduce unfairness, congestion, and/or failure of the network to achieve its goals. As a result, the network may experience improved traffic flows and performance. For example, if the network supports automated manufacturing, the network may provide improved performance for the manufacturing systems. As another example, networks that provide guest access for devices that want to use HiP EDCA may provide an enhanced experience to the devices.

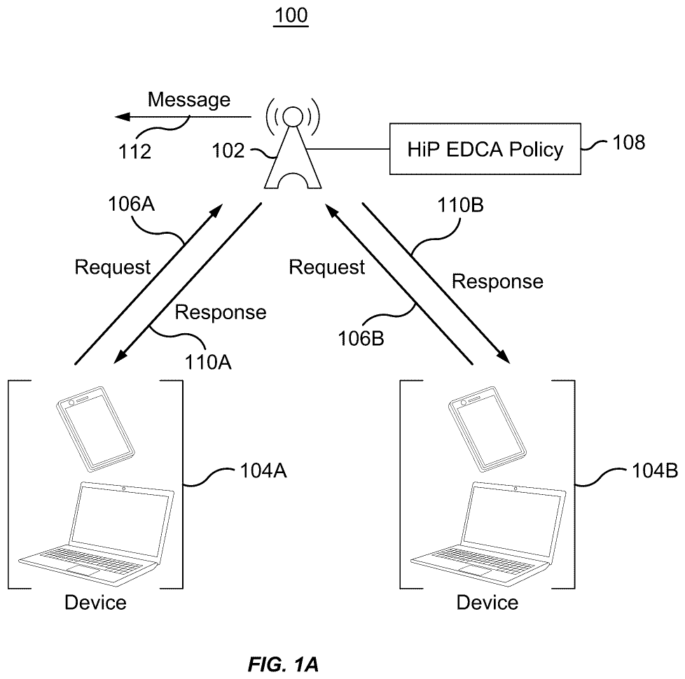

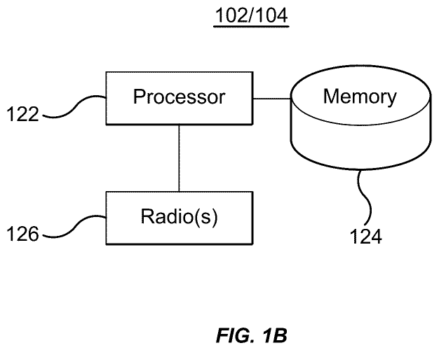

FIG. 1A illustrates an example system 100, which may be a network deployment that provides wireless communication (e.g., Wi-Fi communications). As seen in FIG. 1A, the system 100 includes one or more access points 102 and multiple devices 104 (which may also be referred to as client devices). Generally, an access point 102 maintains and enforces a HiP EDCA policy that governs how a device 104 accesses a transmission medium using HiP EDCA.

The access point 102 may be a network device that facilitates wireless communication (e.g., Wi-Fi communication) in the system 100. The device 104 connects to the access point 102, and the access point 102 may facilitate communication to and from the device 104. For example, the access point 102 may receive messages from the device 104 and direct those messages towards their destination. As another example, the access point 102 may receive messages intended for the device 104 and direct those messages to the device 104. The access point 102 may also exchange messages with other access points 102.

The device 104 may be any suitable device that wirelessly connects to an access point 102. As an example and not by way of limitation, the device 104 may be a computer, a laptop, a wireless or cellular telephone, an electronic notebook, a personal digital assistant, a tablet, or any other device capable of receiving, processing, storing, or communicating information with other components of the system 100. The device 104 may be a wearable device such as a virtual reality or augmented reality headset, a smart watch, or smart glasses. The device 104 may also include a user interface, such as a display, a microphone, keypad, or other appropriate terminal equipment usable by the user. The device 104 may include a hardware processor, memory, or circuitry configured to perform any of the functions or actions of the device 104 described herein. For example, a software application designed using software code may be stored in the memory and executed by the processor to perform the functions of the device 104.

In the example of FIG. 1A, the system 100 includes the devices 104A and 104B. Generally, the devices 104A and 104B may access the transmission medium to communicate with the access point 102. In some instances, the devices 104A and 104B or the access point 102 may use HiP EDCA to gain prioritized access to the transmission medium. The access point 102 maintains and enforces a HiP EDCA policy 108 that governs how and when the devices 104A and 104B and/or the access point 102 may use HiP EDCA to access the transmission medium. For example, the HiP EDCA policy 108 may set limitations on the devices 104A and 104B, traffic types, flows, transmission opportunities, schedules, etc. that are allowed to have prioritized access to the transmission medium. The access point 102 may or may not apply the same HiP EDCA policy to the access point's 102 use of HiP EDCA, or a weaker version of the policy may be applied for use of HiP EDCA by the AP. When the devices 104A and 104B indicate to the access point 102 that the devices 104A and 104B may use HiP EDCA, the access point 102 may negotiate the HiP EDCA usage with the devices 104A and 104B. For example, the device 104A may communicate a request 106A to use HiP EDCA to access the transmission medium (e.g., as a permitted channel access technique). The access point 102 may compare the requested usage with the HiP EDCA policy 108. If the requested use is allowed under the HiP EDCA policy 108, the access point 102 may grant the device 104A permission to use HiP EDCA. The access point 102 may also communicate a response 110A to the device 104A to inform the device 104A of any limitations or restrictions indicated in the HiP EDCA policy 108. If the requested use is not allowed under the HiP EDCA policy 108, the access point 102 may deny the device 104A permission to use HiP EDCA for the requested use and indicate the denial in the response 110A. In some instances, the access point 102 may also provide an explanation or counter-proposal in the response 110A that indicates to the device 104A how to adjust the request for the device 104A to be granted permission under the HiP EDCA policy 108. For example, the access point 102 may indicate adjustments to parameters, traffic types, flows, etc. that will be granted permission under the HiP EDCA policy 108. The device 104A may adjust the request, and the access point 102 may subsequently grant the requested access. The device 104B and the access point 102 may similarly use the request 106B and the response 110B to negotiate HiP EDCA usage. In some instances, the requests 106 may be referred to as HiP EDCA requests, and the responses 110 may be referred to as HiP EDCA responses.

In some instances, the access point 102 may consider information other than the HiP EDCA policy 108 when negotiating with the devices 104A and 104B. For example, the access point 102 may consider static and dynamic parameters, including congestion, fairness, and/or the continued ability to achieve goals of the network (e.g., goals of automated manufacturing) in determining whether to allow, deny, or counter-propose and/or determining the limitations or restrictions for HiP EDCA usage.

In some embodiments, the access point 102 may advertise the HiP EDCA policy 108 upfront to the devices 104A and 104B. For example, the access point 102 may broadcast or communicate a message 112 that is received by the devices 104A and 104B. The message 112 may indicate that the access point 102 allows use of HiP EDCA according to a portion of the HiP EDCA policy 108. Additionally, the message 112 may indicate the portion of the HiP EDCA policy 108. The devices 104A and 104B may still negotiate HiP EDCA use with the access point 102 using the requests 106 and the responses 110 as discussed above. In some instances, however, because the message 112 indicates the portion of the HiP EDCA policy 108, the devices 104A and 104B may skip the negotiation using the requests 106 and responses 110 and begin using HiP EDCA with the access point 102 if the usage complies with the portion of the HiP EDCA policy 108. For example, if the message 112 indicates that the devices 104A and 104B may use HiP EDCA for voice traffic, then the devices 104A and 104B may skip the negotiation using the requests 106 and responses 110 for voice traffic. The devices 104A and 104B, however, may negotiate using the requests 106 and responses 110 for other types of traffic, such as video traffic.

In some embodiments, the access point 102 may use the message 112 to signal whether the access point 102 supports HiP EDCA. For example, the message 112 may include an ultra-high-rate (UHR) capabilities element that signals whether the access point 102 supports HiP EDCA. As another example, the access point 102 may signal whether the access point 102 supports a particular Wi-Fi standard (e.g., 11bn).

After establishing with the devices 104 how HiP EDCA should be used in the system 100, the access point 102 may broadcast a signal (which may be referred to as a defer signal) that indicates the start of a time period when HiP EDCA is used. The signal may also indicate a duration of the time period. During the time period, the devices 104 that are allowed to use HiP EDCA may begin accessing the transmission medium with prioritized access. For example, the devices 104 may back off for a random amount of time and then transmit. The devices 104 that are not allowed to use HiP EDCA may refrain from transmitting during the duration. The access point 102 may repeat the time period when HiP EDCA is used any number of times. For example, the access point 102 may transmit another defer signal indicating a duration, and the devices 104 that are allowed to use HiP EDCA may again access the transmission medium with prioritized access during the duration. The access point 102 and/or the devices 104 may transmit acknowledgements to any of the signals or messages transmitted by the devices 104 and/or the access point 102.

If the HiP EDCA usage by a device 104 does not conform to the HiP EDCA policy 108, then the access point 102 may deny the HiP EDCA usage. In some instances, the access point 102 may transmit unsolicited messages that revoke or change the HiP EDCA usage established through the prior negotiations with the devices 104. Alternatively or additionally, the access point 102 may reduce access to the transmission medium or to the link, or the access point 102 may disassociate, deauthenticate, or disconnect the devices 104 from the access point 102. In this manner, the access point 102 manages HiP EDCA usage according to the HiP EDCA policy 108.

FIG. 1B illustrates an example access point 102 or device 104 of the system 100 of FIG. 1A. As seen in FIG. 1B, the access point 102 and/or device 104 include a processor 122, a memory 124, and one or more radios 126.

The processor 122 is any electronic circuitry, including, but not limited to one or a combination of microprocessors, microcontrollers, application specific integrated circuits (ASIC), application specific instruction set processor (ASIP), and/or state machines, that communicatively couples to the memory 124 and controls the operation of the access point 102 and/or device 104. The processor 122 may be 8-bit, 16-bit, 32-bit, 64-bit or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 122 may include other hardware that operates software to control and process information. The processor 122 executes software stored on the memory 124 to perform any of the functions described herein. The processor 122 controls the operation and administration of the access point 102 and/or device 104 by processing information (e.g., information received from the memory 124 and radios 126). The processor 122 is not limited to a single processing device and may encompass multiple processing devices contained in the same device or computer or distributed across multiple devices or computers. The processor 122 is considered to perform a set of functions or actions if the multiple processing devices collectively perform the set of functions or actions, even if different processing devices perform different functions or actions in the set.

The memory 124 may store, either permanently or temporarily, data, operational software, or other information for the processor 122. The memory 124 may include any one or a combination of volatile or non-volatile local or remote devices suitable for storing information. For example, the memory 124 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 124, a disk, a CD, or a flash drive. In particular embodiments, the software may include an application executable by the processor 122 to perform one or more of the functions described herein. The memory 124 is not limited to a single memory and may encompass multiple memories contained in the same device or computer or distributed across multiple devices or computers. The memory 124 is considered to store a set of data, operational software, or information if the multiple memories collectively store the set of data, operational software, or information, even if different memories store different portions of the data, operational software, or information in the set.

The radios 126 may communicate messages or information using different communication technologies. For example, the access point 102 and/or device 104 may use one or more of the radios 126 for Wi-Fi communications. The access point 102 and/or device 104 may use one or more of the radios 126 to transmit messages and one or more of the radios 126 to receive messages. The access point 102 and/or device 104 may include any number of radios 126 to communicate using any number of communication technologies.

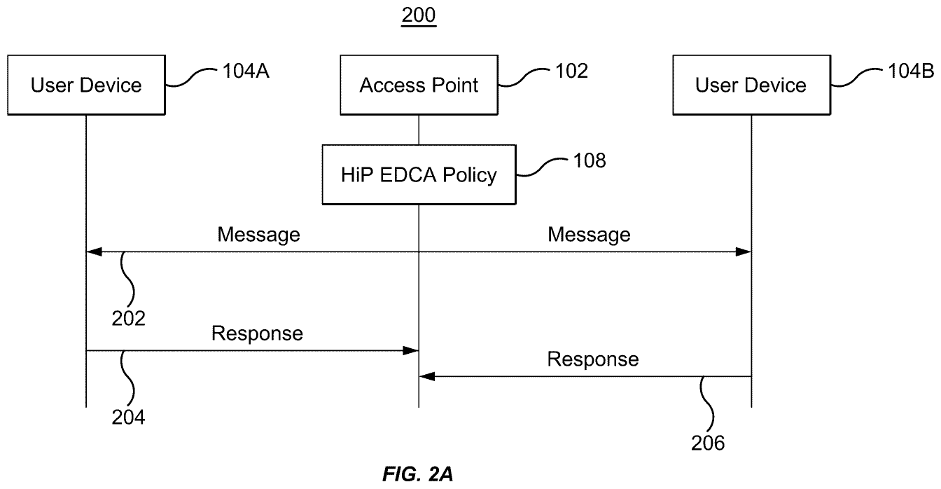

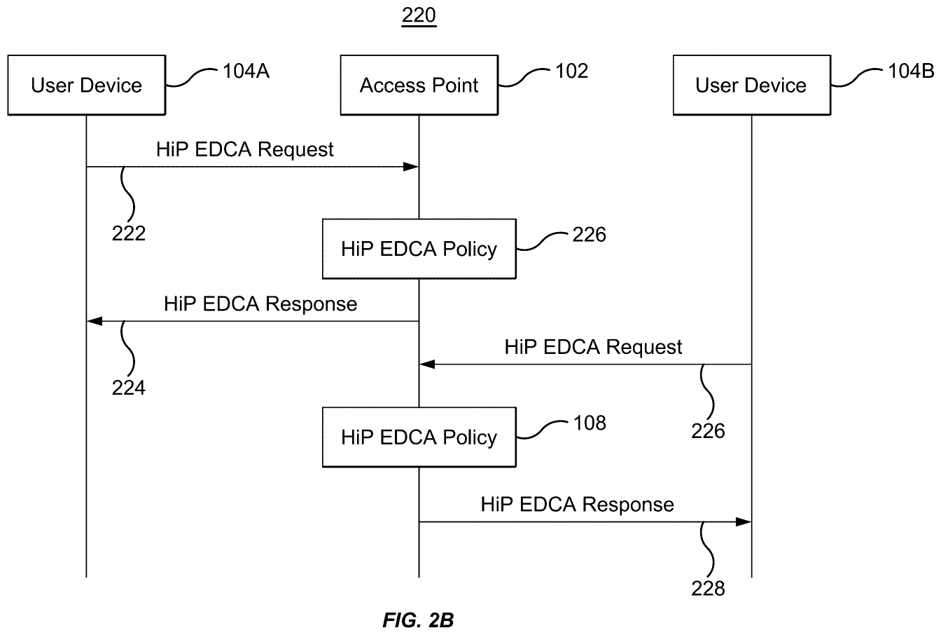

FIG. 2A illustrates an example operation 200 performed by the system 100 of FIG. 1A. Generally, the access point 102 and the devices 104A and 104B perform portions of the operation 200. By performing the operation 200, the access point 102 advertises to the devices 104A and 104B the nature of their access to the transmission medium using HiP EDCA.

At 202, the access point 102 broadcasts a message to the user devices 104A and 104B to advertise the HiP EDCA policy 108 upfront to the devices 104A and 104B. The message may indicate that the access point 102 allows use of HiP EDCA according to a portion of the HiP EDCA policy 108. Additionally, the message 112 may indicate the portion of the HiP EDCA policy 108. In this manner, the access point 102 informs the devices 104A and 104B about the portion of the HiP EDCA policy 108 without the devices 104A and 104B necessarily negotiating HiP EDCA usage with the access point 102. In some embodiments, the message 112 may be a beacon, a probe response, a (re)association response, a fast initial link setup (FILS) discovery frame, a beacon frame, an association response frame, a reassociation response frame, etc. At 204 and 206, the devices 104A and 104B communicate responses back to the access point 102. The responses may be acknowledgements of the message broadcast by the access point 102. In some instances, in addition to the message 112 or as an alternative to the message 112, the access point 102 broadcasts or provides the HiP EDCA policy 108 in a beacon frame, a probe response frame, a FILS discovery frame, an association response frame, a reassociation response frame, or an SCS response frame.

In some embodiments, the message 112 includes one or more channel access parameters to be used for accessing a channel using HiP EDCA. For example, the message 112 may include an arbitration inter-frame spacing number (AIFSN) to be used for HiP EDCA contention. As another example, the message 112 may include one or more parameters indicating a minimum contention window (CW min) and/or a maximum contention window (CW max) to be used for HiP EDCA contention. As another example, the message 112 may include a transmission opportunity limit for HiP EDCA.

In some instances, the devices 104A and 104B may still negotiate HiP EDCA use with the access point 102 as discussed in FIGS. 1A and 2B after the access point 102 broadcasts the message 112 (e.g., if the message 112 indicates that negotiation is required generally or in certain instances). In some instances, however, because the message indicates the portion of the HiP EDCA policy 108, the devices 104A and 104B may skip the negotiation and begin using HiP EDCA with the access point 102 if the usage complies with the portion of the HiP EDCA policy 108. For example, if the message indicates that the devices 104A and 104B may use HiP EDCA for voice traffic, then the devices 104A and 104B may skip the negotiation for voice traffic. The devices 104A and 104B, however, may negotiate for other types of traffic, such as video traffic.

FIG. 2B illustrates an example operation 220 performed by the system 100 of FIG. 1A. Generally, the access point 102 and the devices 104A and 104B perform portions of the operation 220. By performing the operation 220, the access point 102 and the devices 104A and 104B determine the nature of their access and/or negotiate access to the transmission medium using HiP EDCA.

At 222, the device 104A transmits a HiP EDCA request to the access point 102. Using the HiP EDCA request, the device 104A requests prioritized access to the transmission medium. The access point 102 compares the request to the HiP EDCA policy 108 maintained by the access point 102 and/or resource levels (e.g., available and/or consumed; considering both wireless medium resources and internal access point resources) to determine whether the HiP EDCA request conforms with the HiP EDCA policy 108 and/or resource levels (e.g., fall below a resource levels threshold or limit). For example, the access point 102 may determine whether the HiP EDCA policy 108 allows the device 104A to use HiP EDCA. As another example, the access point 102 may determine whether the HiP EDCA request is for a traffic type or flow for which the HiP EDCA policy 108 allows the device 104A to use HiP EDCA.

In the example of FIG. 2B, the access point 102 may determine that the HiP EDCA request conforms to the HiP EDCA policy 108 and/or resource levels. The access point 102 then generates a HiP EDCA response and communicates the HiP EDCA response to the device 104A at 224. The HiP EDCA response may indicate to the device 104A that the HiP EDCA request is granted.

At 226, the device 104B transmits a HiP EDCA request to the access point 102. Using the HiP EDCA request, the device 104B requests prioritized access to the transmission medium. The access point 102 compares the request to the HiP EDCA policy 108 maintained by the access point 102 and/or resource levels to determine whether the HiP EDCA request conforms with the HiP EDCA policy 108 and/or resource levels. For example, the access point 102 may determine whether the HiP EDCA policy 108 allows the device 104B to use HiP EDCA. As another example, the access point 102 may determine whether the HiP EDCA request is for a traffic type or flow for which the HiP EDCA policy 108 allows the device 104B to use HiP EDCA.

In the example of FIG. 2B, the access point 102 may determine that the HiP EDCA request from the device 104B does not conform to the HiP EDCA policy 108 and/or resource levels. The access point 102 then generates a HiP EDCA response and communicates the HiP EDCA response to the device 104B at 228. The HiP EDCA response may indicate to the device 104B that the HiP EDCA request was denied. In some instances, the HiP EDCA response may indicate a reason or explanation for the denial. For example, the HiP EDCA response may indicate aspects of the HiP EDCA request that may be changed for the access point 102 to grant the HiP EDCA request (which may be referred to as a counter-proposal). For example, the HiP EDCA response may indicate that the HiP EDCA request should be limited to certain traffic types or flows. The device 104B may change the HiP EDCA request according to the information in the HiP EDCA response, and the access point 102 may subsequently grant the HiP EDCA request.

As discussed above, the access point 102 and the devices 104A and 104B may perform the operation 220 without performing the operation 200 shown in FIG. 2A or in conjunction with the operation 200 shown in FIG. 2A. For example, the device 104A and/or the device 104B may perform the operation 220 to negotiate HiP EDCA usage without the access point 102 previously advertising the HiP EDCA policy 108 to the devices 104A and 104B. As another example, the device 104A and/or the device 104B may perform the operation 220 to negotiate HiP EDCA usage after the access point 102 advertised the HiP EDCA policy 108 to the devices 104A and 104B (e.g., to negotiate HiP EDCA usage that is not covered by the policy 108).

In some embodiments, the device 104 and/or the access point 102 may use the HiP EDCA request and HiP EDCA response to signal whether the device 104 and/or the access point 102 supports HiP EDCA. For example, the HiP EDCA request and the HiP EDCA response may include an ultra-high-rate (UHR) capabilities element that signals whether the device 104 and/or the access point 102 support HiP EDCA. As another example, the device 104 and/or the access point 102 may signal whether the device 104 and/or the access point 102 support a particular Wi-Fi standard (e.g., 11bn). The signaling may be sent in beacons, probes, probe responses, reassociation requests, reassociation responses, etc.

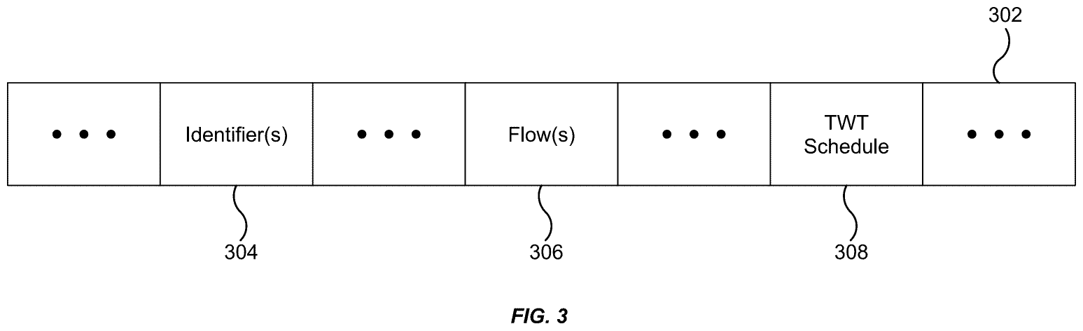

FIG. 3 illustrates an example HiP EDCA request 302 in the system 100 of FIG. 1A. Generally, a user device may communicate the HiP EDCA request 302 to an access point to negotiate prioritized access to a transmission medium using HiP EDCA.

As seen in FIG. 3, the HiP EDCA request 302 includes one or more portions that indicate different information about the prioritized access. For example, the HiP EDCA request 302 may include a portion 304 that includes one or more identifiers (e.g., Access Category (AC) identifiers, traffic identifiers (TID(s)), etc.). Each identifier may identify a particular traffic type (e.g., voice traffic, video traffic, data traffic, etc.). The identifiers in the portion 304 may indicate the traffic types for which prioritized access to the transmission medium is being requested. In some embodiments, the portion 304 includes a list of identifiers and/or a bitmap for the identifiers (e.g., with each bit corresponding to a traffic type/traffic identifier).

As another example, the HiP EDCA request 302 may include a portion 306 that identifies one or more traffic flows or the characteristics of the flows (traffic specification (TSPEC) element, stream classification service identifier (SCS ID), quality of service (QoS) Characteristic element, traffic classification (TCLAS) element(s), fully qualified domain name (FQDN), uniform resource identifier (URI), uniform resource locator (URL), application identifier, or similar). Each traffic flow may include a traffic source that produced the flow to the device. For example, the portion 306 may identify a streaming service that produces a traffic flow to the device. As another example, the portion 306 may identify a website that produces a traffic flow to the device. The portion 306 may indicate the traffic flows for which prioritized access to the transmission medium is being requested. In some embodiments, the portion 306 may be a TCLAS element in the HiP EDCA request 302. The traffic classification element may include one or more parameters that identify incoming frames with a particular traffic stream and is thus linked to a particular TSPEC.

As another example, the HiP EDCA request 302 may include a portion 308 that identifies one or more target wake time schedules. The schedule may indicate times when the device and/or access point wakes to access the transmission medium (e.g., using HiP EDCA) (or times when either device is not available). Thus, the information in the portion 308 may indicate times when the device may use (or may not use) HiP EDCA to access the transmission medium.

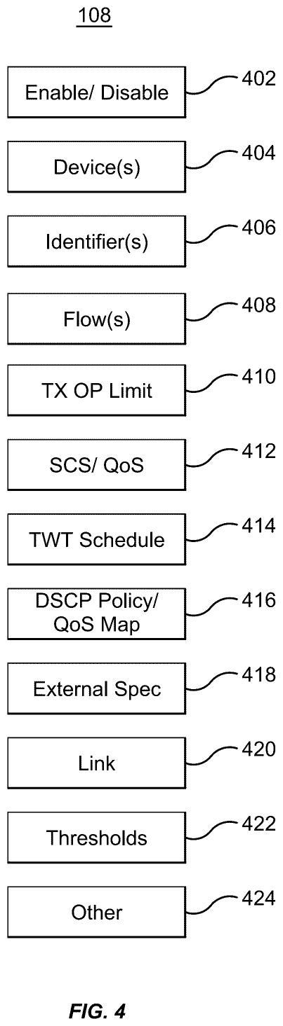

FIG. 4 illustrates an example HiP EDCA policy 108 in the system 100 of FIG. 1A. Generally, an access point may maintain and use the HiP EDCA policy 108 to determine whether prioritized access to a transmission medium should be granted or denied. In some instances, the access point may use the HiP EDCA policy 108 to determine how a request for prioritized access should be adjusted to conform to the HiP EDCA policy 108.

As seen in FIG. 4, the HiP EDCA policy 108 may include information that governs how prioritized access to the transmission medium should be provided. For example, the HiP EDCA policy 108 may include a portion 402 that indicates whether HiP EDCA is enabled or disabled. If HiP EDCA is disabled, then all HiP EDCA requests to the access point may be denied. If HiP EDCA is enabled, then HiP EDCA requests to the access point may be granted.

As another example, the HiP EDCA policy 108 may include a portion 404 that identifies one or more devices. The identified devices may be allowed prioritized access to the transmission medium. If a device that is not identified in the portion 404 transmits a HiP EDCA request to the access point, then the access point may reject the HiP EDCA request. If a device that is identified in the portion 404 transmits a HiP EDCA request to the access point, then the access point may grant the HiP EDCA request.

As another example, the HiP EDCA policy 108 may include a portion 406 that includes one or more identifiers (e.g., traffic identifiers, access category identifiers, frame types, etc.). An identifier may identify a particular traffic type (e.g., voice traffic, video traffic, data traffic, etc.) or frame type that is allowed prioritized access to the transmission medium. If a device transmits a HiP EDCA request that includes an identifier that is not included in the portion 406, then the access point may reject the HiP EDCA request. If the device transmits a HiP EDCA request that includes an identifier that is included in the portion 406, then the access point may grant the HiP EDCA request.

As another example, the HiP EDCA policy 108 may include a portion 408 that identifies one or more traffic flows or the characteristics of traffic flows (e.g., TSPEC element, SCS ID, QoS characteristic element, TCLAS element(s), FQDN, URI, URL, application identifier, or similar). For example, the portion 408 may identify one of more sources of traffic flows. If a device transmits a HiP EDCA request that identifies a traffic flow that is not included in the portion 408, then the access point may reject the HiP EDCA request. If the device transmits a HiP EDCA request that identifies a traffic flow that is included in the portion 408, then the access point may grant the HiP EDCA request.

As another example, the HiP EDCA policy 108 may include a portion 410 that indicates a transmission opportunity (TX OP) limit, which may be an upper limit on the number, consumed time, number per time, number per contention, number per failed contention, number per consecutive failed contentions, or duty cycle of consumed time of HiP transmission opportunities; or a lower limit on their inverses such as minimum time, contentions, failed contentions, consecutive failed contentions between HiP EDCA opportunities. Although the access point may grant prioritized access using HiP EDCA, the transmission opportunity limit may limit the number, consumed time, number per time, number per contention, number per failed contention, number per consecutive failed contentions, or duty cycle of consumed time of transmission opportunities that may be allowed prioritized access to the transmission medium. In some embodiments, the limit may be expressed as a linear value or a value expressed as a mantissa and an exponent with various units relevant to the parameter being signaled. For example, for time, the limit may have units of one, eight, and/or 16 microseconds or transmission units. For duty cycle, the limit may be signaled by an unsigned N field where power(2, N-1) indicates 100%. For rates, scaled values may be used.

As another example, the HiP EDCA policy 108 may include a portion 412 that indicates one or more SCS, TSPEC, or QoS parameters or characteristics. The portion 412 may also include traffic and/or access category identifiers. The information in the portion 412 may be used to determine whether certain flows or traffic or access category identifiers may use HiP EDCA. If a device transmits a HiP EDCA request that includes a traffic or access category identifier or identifies a flow with SCS or QoS parameters or characteristics that comport with the identifiers, parameters, or characteristics in the portion 412, then the access point may grant the HiP EDCA request. If the device transmits a HiP EDCA request that includes a traffic or access category identifier or identifies a flow with SCS or QoS parameters or characteristics that do not comport with the identifiers, parameters, or characteristics in the portion 412, then the access point may deny the HiP EDCA request.

As another example, the HiP EDCA policy 108 may include a portion 414 that includes one or more target wake time schedules, which may indicate times when a device may or may not have prioritized access to the transmission medium. If a device transmits a HiP EDCA request that includes a target wake time schedule that complies with the target wake time schedule in the portion 414, then the access point may grant the HiP EDCA request. If the device transmits a HiP EDCA request that includes a target wake time schedule that does not comply with the target wake time schedule in the portion 414, then the access point may deny the HiP EDCA request. In some instances, the target wake time schedule for a device may be calculated on the fly or preallocated for the device.

As another example, the HiP EDCA policy 108 may include a portion 416 that includes a differentiated services code point (DSCP) policy or a QoS map. The DSCP policy or QoS map may classify or map certain traffic based on application or service type. In some instances, the DSCP policy or QoS map may prevent devices from falsely identifying traffic as needing prioritized access (e.g., using a false traffic identifier). As a result, the access point may use the DSCP policy or QoS map to check whether certain traffic is allowed prioritized access to the transmission medium. This check may happen at first request or subsequently after the access point has analyzed the actual traffic transmitted using HiP EDCA.

As another example, the HiP EDCA policy 108 may include a portion 418 that identifies one or more external specifications. The external specification may be needed for HiP operation and may identify corresponding exchanges (e.g., a Wi-Fi Alliance differentiated service code point policy). The access point may reference or use these external specifications when determining whether to grant prioritized access to the transmission medium. This check may happen at first request or subsequently after the access point has analyzed the actual traffic transmitted using HiP EDCA.

As another example, the HiP EDCA policy 108 may include a portion 420 that includes one or more links. The HiP EDCA policy 108 may be applicable to the links identified in the portion 420, or all links not identified in the portion 420. The access point may use the portion 420 to determine whether the HiP EDCA policy 108 should apply to a particular link. In some embodiments, the portion 420 may be an UHR operation element or another policy element or a variant of a multi-link element, which may be sent in a beacon or probe response.

The HiP EDCA policy 108 may include a portion 422 that indicates other conditions for using HiP EDCA. The portion 422 may include one or more thresholds (e.g., a threshold number of transmission failures for a frame that should be observed, resource level thresholds, congestion level thresholds, etc.) before granting prioritized access to the transmission medium. For example, if too many user devices are using HiP EDCA for too many flows or traffic types, and the resource levels fall below a threshold and/or the congestion levels exceed a threshold (e.g., collision rate, distribution of first HiP slot used, etc.), then the access point may not allow new or additional usage of HiP EDCA. The access point may also cancel or renegotiate HiP EDCA usage with some devices. In some instances, the portion 422 may indicate which frame types (e.g., data frames only or both management and data frames) can trigger HiP EDCA. As another example, the portion 422 may indicate a threshold number of transmission failures (which may be referred to as a retry count) that a device should experience before receiving prioritized access to the transmission medium.

The HiP EDCA policy 108 may include a portion 424 that indicates other information related to using HiP EDCA. For example, the portion 424 may indicate a number of consecutive HiP EDCA attempts or transmissions that are allowed by the access point. If a device performs HiP EDCA attempts or transmissions that meets or exceeds this number, the access point may refuse further HiP EDCA attempts or transmissions from the device. As another example, the portion 424 may indicate whether a device should perform flow level negotiation with the access point before the access point will allow HiP EDCA to be used (e.g., for a particular flow). As another example, the portion 424 may indicate whether the access point will negotiate and potentially allow HiP EDCA usage for traffic that does not otherwise comply with the HiP EDCA policy 108.

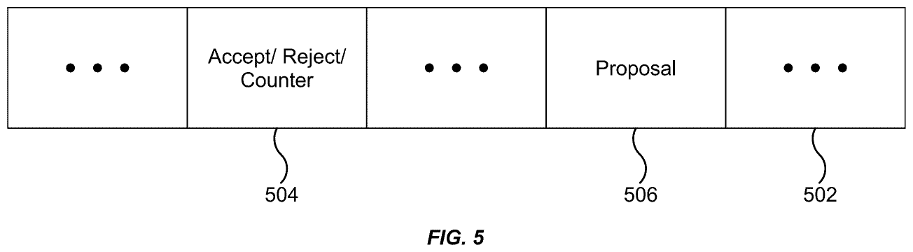

FIG. 5 illustrates an example HiP EDCA response 502 in the system 100 of FIG. 1A. Generally, an access point may communicate the HiP EDCA response 502 to a device to indicate to the device whether prioritized access is granted or denied.

As seen in FIG. 5, the HiP EDCA response 502 includes a portion 504 that indicates whether a HiP EDCA request is accepted, rejected, or countered. If the HiP EDCA request is accepted, then the device may be allowed prioritized access to the transmission medium according to a HiP EDCA policy of the access point. If the HiP EDCA request is denied or rejected, then the device may not be allowed prioritized access to the transmission medium.

If the HiP EDCA request is countered, then the HiP EDCA response 502 may include a portion 506 that includes a proposal. The proposal may indicate changes to the HiP EDCA request that, if made, may cause the access point to allow prioritized access to the transmission medium according to the HiP EDCA policy. For example, the proposal may indicate changes to the traffic identifiers, flows, and/or target wake time schedule indicated in the HiP EDCA request. The proposal may indicate limitations on the amount of HiP contention, the number, consumed time, number per time, number per contention, number per failed contention, number per consecutive failed contentions, or duty cycle of consumed time of HiP transmission opportunities. The device may submit a fresh HiP EDCA request based on the proposal and send the changed HiP EDCA request to the access point. The access point may then grant the changed HiP EDCA request. In this manner, the access point may control how the device gains prioritized access to the transmission medium.

In some embodiments, for some message exchanges, the HiP EDCA request and/or HiP EDCA response may be portions of a SCS request and/or report or response frame. The SCS request may request to use HiP EDCA for flows and or traffic identifiers for which the SCS stream is being created or may request use of HiP EDCA for certain access categories (ACs). This may be achieved by using a bit or field in the QoS characteristics element or in another field within the SCS descriptor element to request HiP EDCA use and/or indicating set of parameters (e.g. ACs, TIDs, TCLAS, or SCS ID for flows) for which HiP EDCA use is being requested. The access point may indicate in the SCS response if the access point allows use of HiP EDCA for the requested SCS stream and/or traffic identifiers. In the SCS response, the access point may also indicate a smaller or alternate set of traffic types for which HiP EDCA use is allowed. For example, if a device requested use of HiP EDCA for TIDs 4 and 5, the access point may allow use of HiP EDCA only for TID 5 and indicate that in the SCS response. In another example, if the device requests use of HiP EDCA for access categories AC_BE and AC_VI, the access point may allow use of HiP EDCA only for AC_VI and indicates that in SCS response.

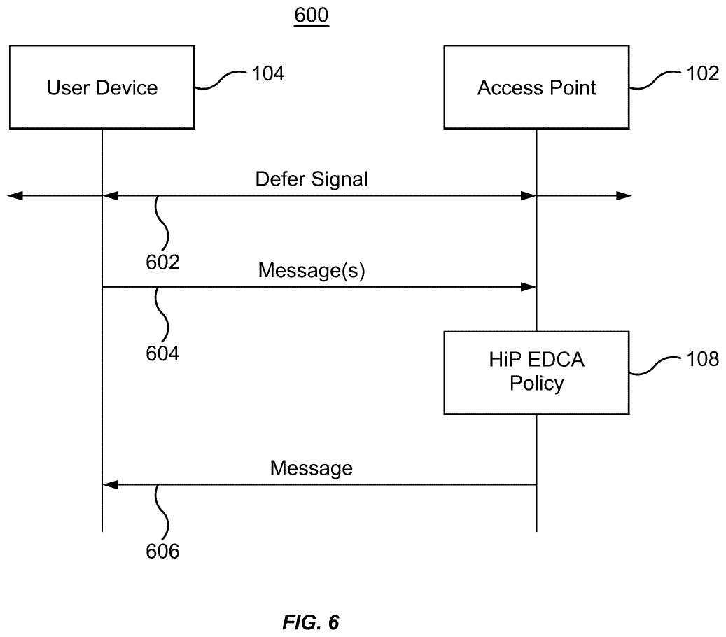

FIG. 6 illustrates an example operation 600 performed by the system 100 of FIG. 1A. Generally, the access point 102 and a device 104 perform the operation 600 for HiP access. By performing the operation 600, the device 104 gains prioritized access to the transmission medium.

Prior to performing the operation 600, the access point 102 and/or the device 104 may have negotiated prioritized access to the transmission medium (i.e., HiP EDCA) (e.g., using the operations 200 and/or 220 shown in FIGS. 2A and/or 2B). When the device 104 and/or the access point 102 determines that prioritized access to the transmission medium is needed, the device 104 and/or the access point 102 may broadcast a defer signal at 602. The defer signal may indicate to the access point 102 and other nearby devices that the device 104 and/or the access point 102 has initiated HiP EDCA contention. The defer signal may indicate a duration for HiP EDCA use. Legacy (HiP-unaware and HiP-disallowed) devices wait for the duration indicated by the defer signal. HiP-permitted devices, including the device 104, may then contend during the protected duration to access the transmission medium. The access point 102 may monitor usage of the defer signal to confirm that the associated device 104 has performed the necessary negotiation with the access point 102 and that the prioritized access conforms to the HiP EDCA policy 108 of the access point 102.

At 604, the device winning the HiP contention (hereafter assumed to be device 104) communicates one or more messages to the access point 102. For example, the device 104 may gain prioritized access to the transmission medium to wirelessly transmit the messages to the access point 102. The access point 102 may continue to confirm that the message transmissions conform to the HiP EDCA policy 108.

If the access point 102 determines that the device 104 is not conforming to the HiP EDCA policy 108, either in this single HiP contention or after a pattern of behavior during recent HiP contentions, then the access point 102 may communicate a message to the device 104 at 606. The message may indicate the remedial action that the access point 102 is taking in response to the violation of the HiP EDCA policy 108. For example, the message may indicate that the access point 102 is revoking or changing the pre-established negotiation with the device for HiP EDCA operation. The message 606 may be an unsolicited management frame that lists a revised negotiation for HiP EDCA operation. As another example, the message may indicate that the access point 102 is reducing access to a link or links (e.g., using load balancing) in response to the violation of the HiP EDCA policy. As another example, the message may indicate that the access point is disassociating from or deauthenticating the device 104 in response to the violation of the HiP EDCA policy.

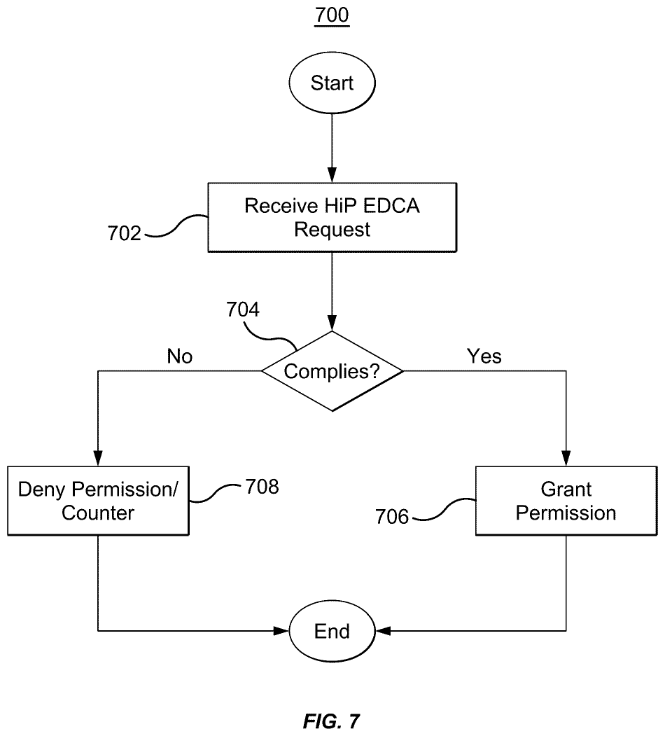

FIG. 7 is a flowchart of an example method 700 performed by an access point (e.g., the access point 102) in the system 100 of FIG. 1A. By performing the method 700, the access point negotiates HiP EDCA use with a device.

At 702, the access point receives a HiP EDCA request from the device. The HiP EDCA request may indicate aspects of the requested prioritized access to the transmission medium. For example, the HiP EDCA request may indicate certain traffic identifiers or identify certain traffic flows for which HiP EDCA is being requested. In some embodiments, the access point may advertise portions of a HiP EDCA policy of the access point prior to 702.

At 704, the access point may determine whether the HiP EDCA request complies with the HiP EDCA policy of the access point. For example, the access point may compare the information in the HiP EDCA request with the information in the HiP EDCA policy. If the HiP EDCA request complies with the HiP EDCA policy (and/or resource levels), then the access point grants permission at 706. The grant may include limitations on the amount or rate of HiP usage. If the HiP EDCA request does not comply with the HiP EDCA policy, then the access points denies permission at 708. In some embodiments, in addition to denying permission, the access point also includes a counter proposal that indicates changes to the HiP EDCA request that would cause the access point to grant permission. The device may change the HiP EDCA request according to the counter proposal.

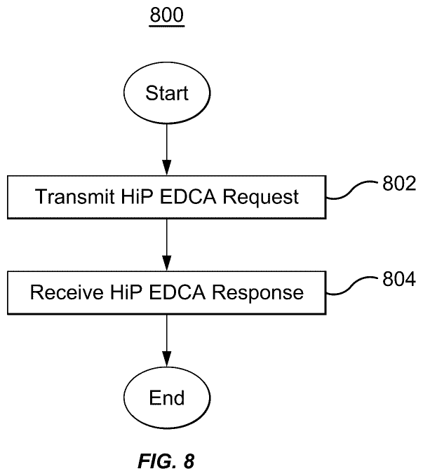

FIG. 8 is a flowchart of an example method 800 performed by a device (e.g., the device 104) in the system 100 of FIG. 1A. By performing the method 800, the device negotiates HiP EDCA use with an access point.

At 802, the device transmits a HiP EDCA request to the access point. The HiP EDCA request may indicate aspects of the requested prioritized access to the transmission medium. For example, the HiP EDCA request may indicate certain traffic identifiers or identify certain traffic flows for which HiP EDCA is being requested.

At 804, the device receives a HiP EDCA response from the access point. The HiP EDCA response may indicate whether the HiP EDCA request complies with a HiP EDCA policy of the access point and/or resource levels. If the HiP EDCA request complies with the HiP EDCA policy and/or resource levels, then the HiP EDCA response may indicate that the HiP EDCA request is granted. The grant may include limitations on the amount or rate of HiP usage. If the HiP EDCA request does not comply with the HiP EDCA policy, then the HiP EDCA response may indicate that the HiP EDCA request is denied. Additionally, the HiP EDCA response may indicate changes to the HiP EDCA request that may be made to cause the access point to grant the HiP EDCA request. The device may change the HiP EDCA request according to the information in the HiP EDCA response and resubmit the HiP EDCA request to the access point. The access point may then grant permission.

In summary, a network includes access points 102 that manage access to and use of HiP EDCA by a HiP EDCA policy 108. Generally, the access point 102 may advertise a HiP EDCA policy, and/or a user device 104 may negotiate with the access point 102 for permission to use HiP EDCA. Before or during the negotiation, the access point 102 may indicate to the device 104 the parameters and/or limitations of using HiP EDCA according to a HiP EDCA policy 108 of the access point 102. If the device 104 agrees to the parameters and/or limitations, the access point 102 may grant access to use HiP EDCA. The access point 102 may then monitor the device's 104 use of HiP EDCA and take remedial action if the device 104 violates the HiP EDCA policy.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A wireless access point comprising:
one or more memories; and
one or more processors communicatively coupled to the one or more memories, the one or more processors configured to, individually or collectively, perform an operation comprising:
broadcasting a message comprising a portion of a High Priority Enhanced Distributed Channel Access (HiP EDCA) policy of the wireless access point; and
providing a user device access to a transmission medium using HiP EDCA according to the HiP EDCA policy.

2. The wireless access point of claim 1, wherein the operation further comprises:
receiving, from the user device, a request to access the transmission medium using HiP EDCA after broadcasting the message;
determining that the request complies with the HiP EDCA policy of the wireless access point; and
in response to determining that the request complies with the HiP EDCA policy, transmitting a response to the user device granting permission to access the transmission medium using HiP EDCA.

3. The wireless access point of claim 2, wherein the operation further comprises:
receiving, from a second user device, a second request to access the transmission medium using HiP EDCA;
determining that the second request fails to comply with the HiP EDCA policy; and
in response to determining that the request fails to comply with the HiP EDCA policy, transmitting a second response to the second user device, wherein the second response indicates an adjustment to the second request.

4. The wireless access point of claim 2, wherein the operation further comprises, in response to determining that the user device is violating the HiP EDCA policy, at least one of:
revoking permission to access the transmission medium using HiP EDCA; or
disassociating with the user device.

5. The wireless access point of claim 2, wherein the request identifies one or more traffic types or one or more traffic flows and wherein determining that the request complies with the HiP EDCA policy comprises determining that the HiP EDCA policy allows access to the transmission medium using HiP EDCA for the one or more traffic types or the one or more traffic flows.

6. The wireless access point of claim 5, wherein the response grants permission to access the transmission medium using HiP EDCA for a subset of the one or more traffic types or a subset of the one or more traffic flows.

7. The wireless access point of claim 5, wherein the one or more traffic types include one or more of access category identifiers or one or more traffic identifiers.

8. The wireless access point of claim 2, wherein the request requests access to the transmission medium over a first link and wherein the operation further comprises:
receiving, from a second user device, a second request to access the transmission medium using HiP EDCA over a second link; and
determining that the second request complies with a second HiP EDCA policy for the second link different from the HiP EDCA policy.

9. The wireless access point of claim 2, wherein transmitting the response to the user device is further based on the request conforming with a resource levels limit.

10. The wireless access point of claim 2, wherein the response comprises a limitation on an amount or rate of HiP EDCA usage.

11. The wireless access point of claim 2, wherein the request is a stream classification service (SCS) request and wherein the response is an SCS response.

12. The wireless access point of claim 1, wherein the HiP EDCA policy indicates at least one of:
whether HiP EDCA is enabled or disabled;
a number of transmission failures that should be experienced before HiP EDCA usage should be allowed;
one or more access categories (ACs) to which traffic should belong to use HiP EDCA;
one or more traffic identifiers (TIDs) to which traffic should belong to use HiP EDCA;
a number of allowed consecutive HiP EDCA attempts;
a type of frames for which HiP EDCA usage is allowed;
whether flow level negotiation should be used to use HiP EDCA; or
whether negotiation with the wireless access point for use of HiP EDCA for traffic that does not comply with the HiP EDCA policy is supported.

13. The wireless access point of claim 1, wherein the message comprises one or more of:
an arbitration inter-frame space number to be used for HiP EDCA contention;
a minimum contention window to be used for HiP EDCA contention;
a maximum contention window maximum to be used for HiP EDCA contention; or
a transmission opportunity limit.

14. The wireless access point of claim 1, wherein the operation further comprises providing the HiP EDCA policy in one or more of a beacon frame, a probe response frame, a fast initial link setup discovery frame, an association response frame, a reassociation response frame, or an SCS response frame.

15. A method comprising:
broadcasting a message comprising a portion of a HiP EDCA policy of a wireless access point; and
providing a user device access to a transmission medium using HiP EDCA according to the HiP EDCA policy.

16. The method of claim 15, further comprising:
receiving, at the wireless access point and from a user device, a request to access a transmission medium using HiP EDCA;
determining, by the wireless access point, that the request complies with a HiP EDCA policy of the wireless access point; and
in response to determining that the request complies with the HiP EDCA policy, transmitting, by the wireless access point, a response to the user device granting permission to access the transmission medium using HiP EDCA.

17. The method of claim 16, further comprising:
receiving, from a second user device, a second request to access the transmission medium using HiP EDCA;
determining that the second request fails to comply with the HiP EDCA policy; and
in response to determining that the request fails to comply with the HiP EDCA policy, transmitting a second response to the second user device, wherein the second response indicates an adjustment to the second request.

18. The method of claim 16, further comprising, in response to determining that the user device is violating the HiP EDCA policy, at least one of:
revoking permission to access the transmission medium using HiP EDCA; or
disassociating with the user device.

19. The method of claim 16, wherein the request identifies a traffic type or a traffic flow and wherein determining that the request complies with the HiP EDCA policy comprises determining that the HiP EDCA policy allows access to the transmission medium using HiP EDCA for the traffic type or the traffic flow.

20. A wireless access point comprising:
one or more memories; and
one or more processors communicatively coupled to the one or more memories, the one or more processors configured to, individually or collectively, perform an operation comprising:
receiving, from a user device, a request to access a transmission medium using HiP EDCA;
determining that the request complies with a HiP EDCA policy of the wireless access point; and
in response to determining that the request complies with the HiP EDCA policy, transmitting a response to the user device granting permission to access the transmission medium using HiP EDCA.
